(19) United States
(12) Patent Application Publication
(10) Pub. No.: US 2017/0291201 A1
(43) Pub. Date: Oct. 12, 2017

(54) METHOD FOR GROUNDWATER REMEDIATION USING SUSTAINED-RELEASE PERSULFATE TABLETS

(71) Applicants: Ku-Fan Chen, Nantou (TW); Wei-Yu Chen, Nantou (TW); Ting-Nien Wu, Nantou (TW); Yu-Chen Chang, Nantou (TW)

(72) Inventors: Ku-Fan Chen, Nantou (TW); Wei-Yu Chen, Nantou (TW); Ting-Nien Wu, Nantou (TW); Yu-Chen Chang, Nantou (TW)

(73) Assignee: NATIONAL CHI NAN UNIVERSITY, Nantou (TW)

(21) Appl. No.: 15/092,251

(22) Filed: Apr. 6, 2016

(51) Int. Cl. B09C 1/00; B29C 43/00

(52) U.S. Cl. CPC B09C 1/002; B29C 43/003; C02F 2103/06

(57) ABSTRACT

The present invention provides a method for groundwater remediation using sustained-release persulfate tablets, which is to synthesize the persulfate and cellulose with specific ratio to form a remediated tablet, and the manufacturing process is operated under the specific pressure. In the composition of the tablet, the persulfate is used as an oxidant while the cellulose is used as a coating agent. The compound of the tablet is coated with the cellulose to slow the releasing rate of the compound and improve the releasing time of the persulfate in the water.

### FIELD OF THE INVENTION

The present invention relates to a method for groundwater remediation using sustained-release persulfate tablets, and more particularly to a method using tablets made by mixing persulfate and cellulose under a predetermined pressure.

### BACKGROUND OF THE INVENTION

Nowadays, the groundwater pollution occurred by gasoline and other petroleum hydrocarbons is a common and serious problem. The main source of pollution includes leaking underground storage tanks, industrial wastes or accidental spills. Since the pipelines of the gas stations and the large oil storage tanks are equipped underground, the oil is more likely to leak from pipelines because of earthquake, poor construction or other human factors. The United States has more than 2,000,000 oil storage tanks, and according to statistics, over 35% of the oil storage tanks have leaking problem. Cases of domestic oil pollution are increasing currently. The problems of soil and groundwater pollution have also become an important issue for domestic and overseas.

The traditional remediation technologies for groundwater are many and varied, and one common technology is called pump and treat. However, the process of pump and treat technology takes a long time and leads to higher costs. Therefore, based on the cost and relevant considerations, the in-site remediation technology (US EPA, 2004) is a most popular approach for polluted groundwater currently.

Another remediation technology needed to be mentioned is in situ chemical oxidation (ISCO). ISCO is accomplished by injecting the oxidant directly into the contaminated medium to achieve the remediation of contaminants. Under ideal conditions, the pollutants will completely oxidize to carbon dioxide, water, or other non-toxic components (ITRC, 2005). Common types of the oxidant include hydrogen peroxide (H₂O₂) [Fenton reagent], permanganate, persulfate, ozone, etc. The use of persulfate as the oxidant is a new development in ISCO (ITRC, 2005). The persulfate is a strong oxidant, and the sulfate radical (SO₄_{^{−}}.) usually activated by heat or metal (such as ferrous) is derived from the persulfate to degrade contaminants fast (Shiying et al., 2008; Chen et al., 2009).

A type of the compound for the conventional ISCO technology is an oxidant-releasing compound, which is composed of persulfate and curing agent in different proportions. The oxidant-releasing compound comprises a plurality of micropores which provide entrances for polluted water with polluted materials. When the oxidant-releasing compound is injected into contaminated water, the persulfate of the oxidant-releasing compound which is water-soluble can be released into contaminated medium to achieve remediation effect.

Another type of the compound for the conventional ISCO technology is a synthetic of the calcium peroxide, sand, peat, cement and water with the ratio (weight ration) of 1.126:0.2:0.183:1:1.744, and the specific gravity of the compound is 1.9 g/cm³. In the remediation process, the calcium peroxide is regarded as the oxidant-releasing agent. The reaction is triggered when the calcium peroxide contacting with the water, and reaction equation is given: 2CaO₂+2H₂O→2 Ca(OH)₂+O₂. When the polluted groundwater flows through the treatment wall which is packed with the oxidant-releasing compounds, the pollutants will react with calcium peroxide in oxidant-releasing compound, resulting in accelerating the reaction of biodegradation of aerobic organic substance. In the compound, the cement is used to condense the other components to form a block of the artificial oxidant-releasing compound, and it also can prevent the calcium peroxide from contacting with the water to cause the reaction, leading to rapidly consuming the calcium peroxide. The peat is used to adjust the pH of the artificial oxidant-releasing compound, and also is used to increase the water permeability of the artificial oxidant-releasing compound. The sand is used to adjust the water permeability and the oxygen releasing rate.

However, these two conventional remediation technologies are disadvantageous because: in these two technologies, the un-activated persulfate or the compound of the cement and the un-activated persulfate is used as the oxidant-releasing agent to remove the pollutants in the water. Nevertheless, the effect of removing pollutants of the un-activated persulfate still needs to improve. For accelerating the removal of the pollutants, heating or adding transition metals such as Fe(II) is required to catalyze the persulfate during the remediation process, and it increases the cost. Moreover, when the Fe(II) is oxidized to Fe(III), the precipitation of Fe(III) will obstruct the aquifer to lower the permeability of aquifer.

The sustained-release persulfate has been in the limelight recently because of its effect of the remediation. The semipermeable adhesive substance used to cover the oxidant such as persulfate can dissolve the oxidant, and extend the releasing time of the oxidant to achieve the effect of remediation. There have been some studies that focus on using paraffin or cement as adhesive substance. The study using cement as adhesive substance shows when persulfate is mixed with cement, a large number of persulfates will be released in the short time because of the precipitation phenomenon. However, due to the solidification of cement, a number of persulfate is un-released and stuck in the compound in releasing process, resulting in the instability of releasing effect. Other studies which focus on using paraffin as adhesive substance show that paraffin is more stable than cement for releasing persulfate. However, in this kind of compound, the persulfate is released so fast during initial stage, and the manufacturing process needs to maintain temperature at 60° C. Also, because of thermal activation, persulfate will be rapidly decomposed at high temperatures (>40° C.), so a large amount of persulfate will be loss during manufacturing process, leading to reducing the release efficiency of product. Additionally, the cement-based or paraffin-based adhesive substances will leave residuals in the water after remediation process, and the subsequent waste disposal process which leads to increase the cost is needed to remove the residuals from the remediated medium. Therefore, there remains a need for a new and improved design for a method for groundwater remediation using sustained-release persulfate tablets to overcome the problems presented above.

### SUMMARY OF THE INVENTION

The present invention provides a method for groundwater remediation using sustained-release persulfate tablets, which is to synthesize the persulfate and cellulose with specific ratio to form a remediated tablet, and the manufacturing process is operated under a specific pressure. In the composition of the tablet, the persulfate is used as an oxidant while the cellulose is used as a coating agent. The compound of the tablet is coated with the cellulose to slow the releasing rate of the compound and improve the releasing time of the persulfate in the water. The persulfate, which is a sustained-release oxidant, is not easy to react with organic materials in the soil, so the required dose of persulfate in the remediated process is less than other oxidants. Therefore, the use of persulfate is not only can remove the pollutants, but also can lower the cost of remediation. By applying the stable persulfate in the persulfate chemical oxidation technology or in situ passive treatment wall, the present invention creates an integrated and oxidative remediation system for oil-polluted groundwater. Moreover, the cellulose expanded in the water because of its specific viscosity can lower the contact areas between the water and the coated compound, so that the compound is less easily dissolved in the water. By packing the sustained-release oxidant tablets composed by the persulfate and the cellulose on the treatment wall, the tablets can preserve sustained-release efficiency in polluted water. Also, since the cellulose can self-discompose in the water, the tablets can save the effort on the subsequent waste disposal process.

Comparing with conventional persulfate tablet for groundwater remediation, the present invention is advantageous because: (i) both the releasing time of oxidant in reaction region and the remediation ability are improved; (ii) the self-decomposed cellulose can prevent the groundwater from secondary contamination; (iii) the persulfate can be sustained under the earth surface for a long time; (iv) the proportions of the oxidant and cellulose can be adjusted depending on the need of polluted medium; and (v) the remediation system in present invention includes the functions of oxidation and activation, which can efficiently remove the pollutants and control the releasing time of the persulfate.

### BRIEF DESCRIPTION OF THE DRAWINGS

FIG. 1 is a flow chart of manufacture of the method for groundwater remediation using sustained-release persulfate tablets in present invention.

FIG. 2 is a flow chart of the method for groundwater remediation using sustained-release persulfate tablets in present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

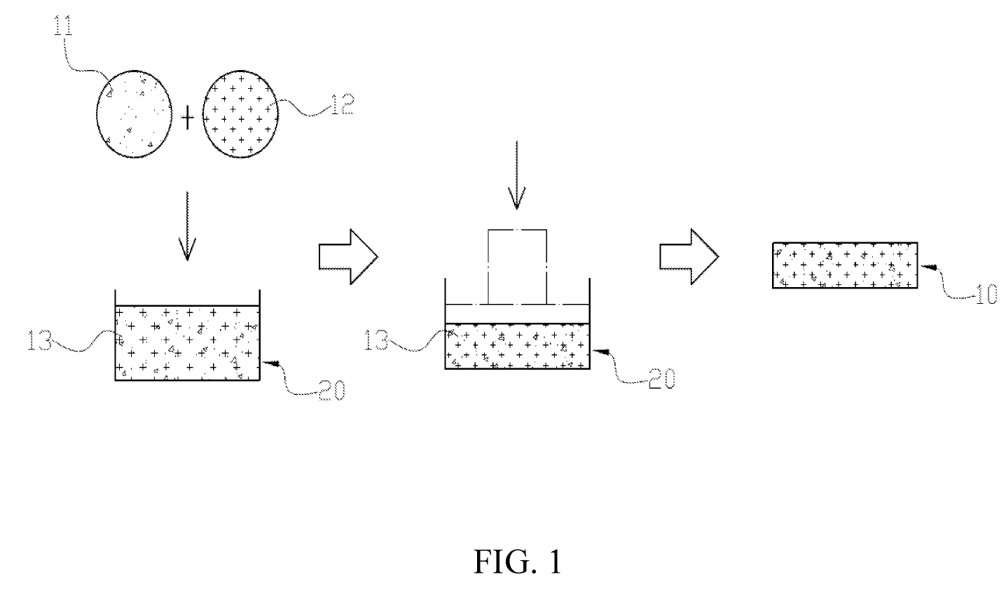

Referring to FIG. 1, the present invention provides a method for groundwater remediation using sustained-release persulfate tablets, which is to synthesize the persulfate (11) and cellulose (12) with a specific ratio to form a compound (13) of remediated tablet (10), and the manufacturing process is operated under a predetermined pressure (5,000-15,000 kg F/cm2). In the composition of the tablet (10), the persulfate (11) is used as an oxidant while the cellulose (12) is used as a coating agent. The compound (13) of the tablet (10) is coated with the cellulose (12) to slow the releasing rate of the compound (13) and improve the releasing time of the persulfate (11) in the water. The persulfate (11), which is a sustained-release oxidant, is not easy to react with organic materials in the soil, so the required dose of persulfate (11) in the remediated process is less than other oxidants. Therefore, the use of persulfate (11) is not only can remove the pollutants, but also can lower the cost of remediation. By applying the stable persulfate (11) in the persulfate chemical oxidation technology or in situ passive treatment wall, the present invention creates an integrated and oxidative remediation system for oil-polluted groundwater. Moreover, the cellulose (12) expanded in the water because of its specific viscosity can lower the contact areas between the water and the coated compound (13), so that the compound (13) is less easily dissolved in the water. By packing the sustained-release oxidant tablets (10) composed by the persulfate (11) and the cellulose (12) on the treatment wall, the tablets (10) can preserve sustained-release efficiency in polluted water. Also, since the cellulose (12) can self-discompose in the water, the tablets (10) can save the effort on the subsequent waste disposal process.

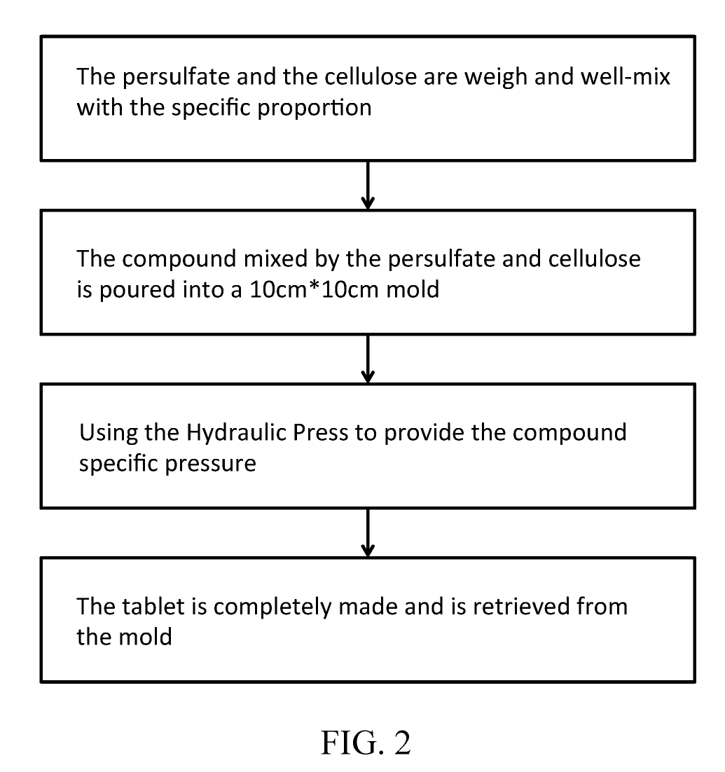

Referring to FIGS. 1 and 2, the manufacturing process of tablets includes following steps: (i) weighing and well-mixing the persulfate (11) and cellulose (12) with the specific ratio; (ii) collecting the compound (13) in said step (i) into a 10 cm*10 cm mold (20); (iii) putting the mold into the Hydraulic Press and providing the compound (13) the predetermined pressure to produce tablets (iv) retrieving and dissembling mold to obtain the tablets.

In one embodiment, the cellulose (12) is hydroxypropyl methyl cellulose.

In another embodiment, the compound (13) can further mix with ferrous and citric acid.

The sustained-release persulfate has been in the limelight recently because of its effect of the remediation. The adhesive substance used to cover the oxidant such as persulfate can efficiently extend the releasing time of the oxidant and achieve the long-term effect of remediation. There have been some studies that focus on using paraffin or cement as adhesive substance. The study using cement as adhesive substance shows when persulfate is mixed with cement, a large number of persulfates will be released in the short time because of the precipitation phenomenon. However, due to the solidification of cement, a number of persulfate is un-released and stuck in the compound in releasing process, resulting in the instability of releasing effect. Other studies which focus on using paraffin as adhesive substance show that paraffin is more stable than cement for releasing persulfate. However, in this kind of compound, the manufacturing process needs to maintain temperature at 60° C., and persulfate will be rapidly decomposed at high temperatures (>40° C.) because of thermal activation. As a result, a large amount of persulfate will be loss during manufacturing process, leading to reducing the release efficiency of product. Additionally, the cement-based or paraffin-based adhesive substances will leave residuals in the water after remediation process, and the subsequent waste disposal process which leads to increase the cost is needed to remove the residuals from the remediated medium. The present invention is to synthesize the persulfate (11) and cellulose (12) under the predetermined pressure to form a remediated tablet (10). Because of the viscosity of the cellulose (12), the persulfate (11) can preserve sustainability release efficiency in groundwater, and achieve the long-term remediation. Also, since the cellulose (12) can self-discompose in the water, the tablets (10) in present invention can save the effort on the subsequent waste disposal process. Depending on the degree of contamination in groundwater, the ferrous can be added into the persulfate (11) to increase the releasing rate.

As shown in table 1, the present invention adjusted the ratio of the persulfate (10) and cellulose (11) and the experimental pressure to obtain the best effect of sustained-release persulfate tablet. According to the result shown in the table 2, 3 and 4, through difference of pressure, hydroxypropyl methyl cellulose proportion, persulfate content on batch release experiment, type of hydropropyl methyl cellulose, the sustained-release persulfate tablet can be accumulated about 10 days. In Summary, the present invention provides an oxidative remediation approach for polluted groundwater. The tablet (10) which uses hydroxypropyl methyl cellulose (12) as coating agent can steadily release persulfate (11) for 10 days in pollutants from methyl tert-butyl ether, resulting in lowering the cost.

TABLE 1
The proportion of the persulfate and
the hydroxypropyl methyl cellulose

| | | | proportion of | |
|---|---|---|---|---|
| | | Persulfate | coating material | Pressure |
| Test ID | Coating Material | (g) | (w/w) | (kg F/cm2) |
| B1 | hydroxypropyl | 10 | 0.3 | 5,000 |
| B2 | methyl cellulose | | | 10,000 |
| B3 | | | | 15,000 |
| C1 | hydroxypropyl | 10 | 0.1 | 5,000 |
| C2 | methyl cellulose | | 0.3 | |
| C3 | | | 0.5 | |
| D1 | hydroxypropyl | 10 | 0.5 | 5,000 |
| D2 | methyl cellulose | 30 | | |
| D3 | | 50 | | |

Comparing with conventional persulfate tablet for groundwater remediation, the present invention is advantageous because: (i) both the releasing time of oxidant in reaction region and the remediation ability are improved; (ii) the self-decomposed cellulose (12) can prevent the groundwater from secondary contamination; (iii) the persulfate (11) can be sustained under the earth surface for a long time; (iv) the proportions of the oxidant and cellulose (12) can be adjusted depending on the need of polluted medium; and (v) the remediation system in present invention includes the functions of oxidation and activation, which can efficiently remove the pollutants and control the releasing time of the persulfate (11).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A method for groundwater remediation using sustained-release persulfate tablets, comprising: a compound mixing by the persulfate and the cellulose with specific ratio to form a remediated tablet, and the manufacturing process operated under a predetermined pressure, in the composition of the tablet, the persulfate used as an oxidant while the cellulose used as a coating agent, the compound of the tablet coated with the cellulose to slow the releasing rate of the compound and improve the releasing time of the persulfate in the water, the tablet creating an integrated and oxidative remediation system for polluted groundwater to lower the cost of remediation and improve the efficiency of removing pollutants.

2. The method for groundwater remediation using sustained-release persulfate tablets of claim 1, wherein the persulfate and the cellulose are weighed and well-mixed with the specific ratio, and the compound mixed by the persulfate and the cellulose is poured into the mold.

3. The method for groundwater remediation using sustained-release persulfate tablets of claim 1 and 2, wherein the manufacturing process of tablet is operated under a predetermined pressure between 5,000 to 15,000 (kg F/cm2).

4. The method for groundwater remediation using sustained-release persulfate tablets of claim 1 and 2, wherein the cellulose is hydroxypropyl methyl cellulose.

5. The method for groundwater remediation using sustained-release persulfate tablets of claim 1 and 2, wherein the compound further mixes with ferrous and citric acid.

6. The method for groundwater remediation using sustained-release persulfate tablets of claim 2, wherein the compound of the persulfate and the cellulose is poured into a 10 cm*10 cm mold.
